(19) United States
(12) Patent Application Publication
(10) Pub. No.: US 2015/0253863 A1
(43) Pub. Date: Sep. 10, 2015

(54) Image Processor Comprising Gesture Recognition System with Static Hand Pose Recognition Based on First and Second Sets of Features

(71) Applicant: Avago Technologies General IP (Singapore) Pte. Ltd., Singapore (SG)

(72) Inventors: Dmitry Nicolaevich Babin, Moscow (RU); Ivan Leonidovich Mazurenko, Khimki (RU); Alexander Alexandrovich Petyushko, Bryansk (RU); Aleksey Alexandrovich Letunovskiy, Moscow (RU); Denis Vladimirovich Zaytsev, Dzerzhinsky (RU)

(21) Appl. No.: 14/640,492

(22) Filed: Mar. 6, 2015

(30) Foreign Application Priority Data
Mar. 6, 2014 (RU) 2014108870

(51) Int. Cl. G06F 3/01; G06K 9/52; G06K 9/00; G06K 9/46; G06F 3/03

(52) U.S. Cl. CPC G06F 3/017; G06K 9/46; G06F 3/0304; G06K 9/00355; G06K 9/52; G06K 2009/4666

(57) ABSTRACT

An image processing system comprises an image processor having image processing circuitry and an associated memory. The image processor is configured to implement a gesture recognition system comprising a static pose recognition module. The static pose recognition module is configured to identify a hand region of interest in at least one image, to obtain a vocabulary of hand poses, to estimate a plurality of hand features based on the hand region of interest, the plurality of hand features comprising a first set of features estimated from the hand region of interest and a second set of features comprising at least one feature estimated using a transform on a contour of the hand region of interest, and to recognize a static pose of the hand region of interest based on the first set of features and the second set of features, wherein respective numbers of features in the first set of features and the second set of features are based at least in part on a size of the vocabulary of hand poses.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system comprising a static pose recognition module. The static pose recognition module is configured to identify a hand region of interest in at least one image, to obtain a vocabulary of hand poses, to estimate a plurality of hand features based on the hand region of interest, the plurality of hand features comprising a first set of features estimated from the hand region of interest and a second set of features comprising at least one feature estimated using a transform on a contour of the hand region of interest, and to recognize a static pose of the hand region of interest based on the first set of features and the second set of features, wherein respective numbers of features in the first set of features and the second set of features are based at least in part on a size of the vocabulary of hand poses.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a static pose recognition module in an illustrative embodiment.

FIG. 2 is a flow diagram of an exemplary static pose recognition process performed by the static pose recognition module in the image processor of FIG. 1.

FIG. 3 is a flow diagram of another exemplary static pose recognition process performed by the static pose recognition module in the image processor of FIG. 1.

FIG. 4 illustrates an estimation of distance vectors for a contour.

FIG. 5 illustrates an estimation of hand features using a transform on a contour of a hand region of interest.

FIG. 6 illustrates a hand pose vocabulary.

FIG. 7 illustrates a pose collision graph.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves recognizing static poses in one or more images.

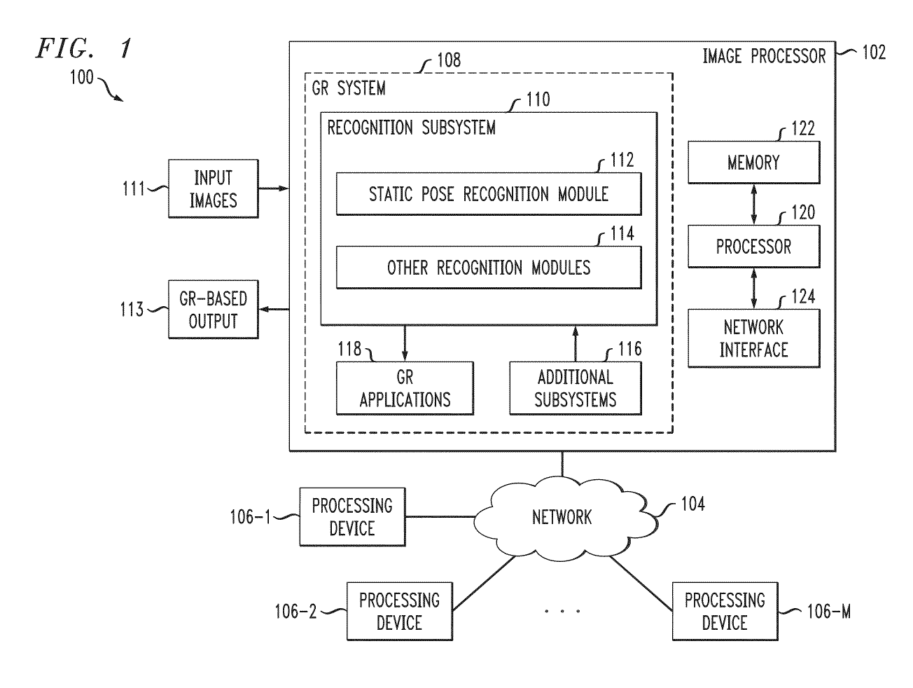

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 110 within a gesture recognition (GR) system 108. The GR system 108 in this embodiment processes input images 111 from one or more image sources and provides corresponding GR-based output 113. The GR-based output 113 may be supplied to one or more of the processing devices 106 or to other system components not specifically illustrated in this diagram.

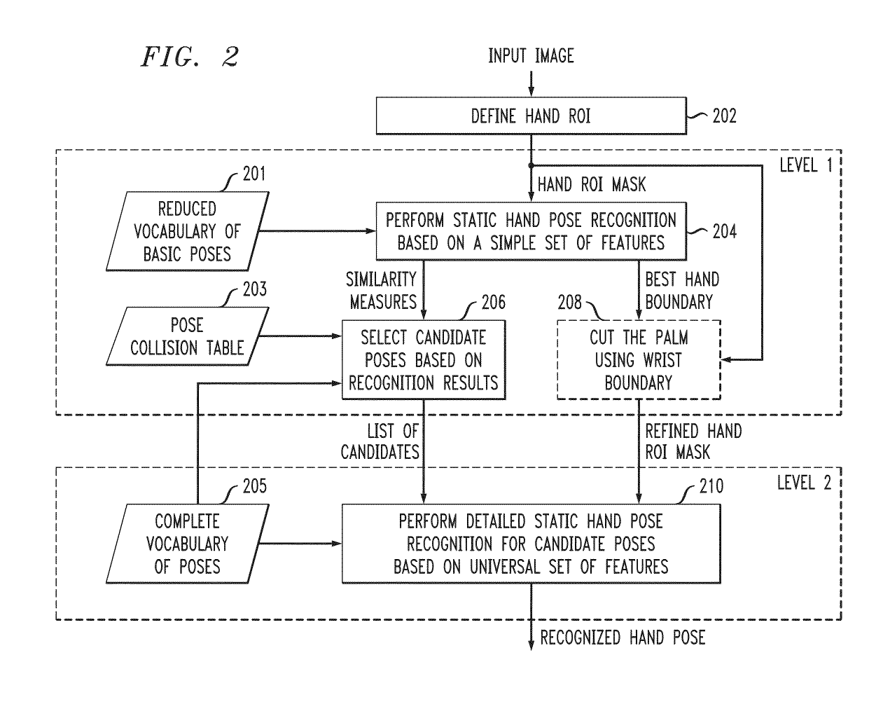

The recognition subsystem 110 of GR system 108 more particularly comprises a static pose recognition module 112 and one or more other recognition modules 114. The other recognition modules 114 may comprise, for example, respective recognition modules configured to recognize cursor gestures and dynamic gestures. The operation of illustrative embodiments of the GR system 108 of image processor 102 will be described in greater detail below in conjunction with FIGS. 2 through 7.

The recognition subsystem 110 receives inputs from additional subsystems 116, which may comprise one or more image processing subsystems configured to implement functional blocks associated with gesture recognition in the GR system 108, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the GR system 108 are described in PCT International Application PCT/US13/56937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the GR system 108 are described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 110 generates GR events for consumption by one or more of a set of GR applications 118. For example, the GR events may comprise information indicative of recognition of one or more particular gestures within one or more frames of the input images 111, such that a given GR application in the set of GR applications 118 can translate that information into a particular command or set of commands to be executed by that application. Accordingly, the recognition subsystem 110 recognizes within the image a gesture from a specified gesture or pose vocabulary and generates a corresponding gesture pattern identifier (ID) and possibly additional related parameters for delivery to one or more of the GR applications 118. The configuration of such information is adapted in accordance with the specific needs of the application.

Additionally or alternatively, the GR system 108 may provide GR events or other information, possibly generated by one or more of the GR applications 118, as GR-based output 113. Such output may be provided to one or more of the processing devices 106. In other embodiments, at least a portion of set of GR applications 118 is implemented at least in part on one or more of the processing devices 106.

Portions of the GR system 108 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 108.

It should be noted, however, that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the GR applications 118 may be implemented on a different processing device than the subsystems 110 and 116, such as one of the processing devices 106.

Moreover, it is to be appreciated that the image processor 102 may itself comprise multiple distinct processing devices, such that different portions of the GR system 108 are implemented using two or more processing devices. The term “image processor” as used herein is intended to be broadly construed so as to encompass these and other arrangements.

The GR system 108 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 108 from the depth sensor may include a stream of frames comprising respective depth images, with each such depth image comprising a plurality of depth image pixels. For example, a given depth image D may be provided to the GR system 108 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 113 to one or more image destinations. At least a subset of such image sources and image destinations may be implemented at least in part utilizing one or more of the processing devices 106.

Accordingly, at least a subset of the input images 111 may be provided to the image processor 102 over network 104 for processing from one or more of the processing devices 106. Similarly, processed images or other related GR-based output 113 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 112, 114, 116 and 118 of image processor 102. One possible example of image processing circuitry that may be used in one or more embodiments of the invention is an otherwise conventional graphics processor suitably reconfigured to perform functionality associated with one or more of the components 112, 114, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 113 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 110 and 116 and the GR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

Embodiments of the invention provide a number of advantages relative to conventional GR systems. GR uses a wide variety of techniques for classifying a gesture by means of image processing and pattern recognition. Hand and face gesture recognition are two common types of gestures used in GR systems, as hands and faces are among the most informative parts of human bodies. In particular, hand gestures allow for a wide variety of personal-invariant recognizable and well-separable data input sources.

Some embodiments are well suited for GR involving still-frame-based recognition of static hand poses as one of a predefined set of “alphabet” poses or postures or rejection as an unknown pose. A predefined set of alphabet poses is more generally referred to herein as a vocabulary of poses or postures. Other embodiments perform perception, tracking and recognition of hand and hand part movement including velocity, direction, magnitude and trajectory in space. In still other embodiments, an integral GR system joins static hand pose recognition and perception, tracking and recognition of hand and hand part movement, thus providing considerable synergetic effects for recognition quality.

Static hand pose recognition in some embodiments includes accurate and high-quality hand movement analysis involving determination of palm shape and the location of different parts of the hand including fingers, wrists and upper parts of hands. In these embodiments, palm shape detection procedures are used. In one exemplary palm shape detection procedure, a palm contour is found and the palm is cut from the whole scene for further processing. A hand contour can be extracted from a 2D edge shape. To classify a hand shape by means of hand contour analysis, a possible first step in some embodiments is to separate or otherwise distinguish the palm from the rest of the hand. Exemplary techniques for such analysis are described in Russian Patent Application No. 2013134325, filed Jul. 22, 2013 and entitled “Gesture Recognition Method and Apparatus Based on Analysis of Multiple Candidate Boundaries,” which is commonly assigned herewith and incorporated by reference herein.

In some embodiments, sophisticated pattern recognition techniques utilize a database or hand pose vocabulary of supported hand poses to find the best match(es) for a hand pose extracted from a given frame. Examples of such pattern recognition techniques include least squares analysis, decision trees, Gaussian mixture models (GMMs), etc. One or more measures of an image-to-pattern matching may be used. Logarithmic likelihood ratio (LLR) is one such measure which enables comparison of competing recognition decisions and reliability estimations.

A number of factors contribute to the complexity and difficulty of high quality hand pose recognition. By way of example, the distance to a hand changes in time even within the same static gesture, therefore its size and consequently its palm spatial resolution changes. Thus, in some embodiments on-the-fly hand rescaling is applied to input images 111. As another example, hand position and orientation may change within a same static gesture. To account for these issues, some embodiments apply normalization procedures to input images 111. Normalization procedures include, by way of example, size normalization and rotation and position tracking in a 3D space, which produce from a raw frame a standardized counterpart. The use of normalization procedures in some embodiments can provide advantages relative to techniques which maintain and utilize an extensive database of all possible orientations, positions and scales for every static hand pose. In some embodiments, maintaining such an extensive database may not be feasible using acceptable amounts of computational resources and thus normalization procedures may be used.

One exemplary technique for live hand pose normalization used in some embodiments is the use of an affine transform for normalization. Robust heuristic approaches for performing such normalization are described in Russian Patent Application No. 2013148582, filed Oct. 30, 2013 and entitled “Image Processor Comprising Gesture Recognition System with Computationally-Efficient Static Hand Pose Recognition,” which is commonly assigned herewith and incorporated by reference herein.

In other embodiments, a thin or small set of hand features which are invariant to the above-noted motion, scaling, rotation and other distortion issues may be used to match a static pose in the input images 111 to candidate poses. Techniques for finding efficient, robust and well-defined but not excessive sets of such hand features will be described in further detail below.

Hand pose recognition in some embodiments utilizes a wide variety of simple features of a hand mask for computationally efficient estimation. Hand postures or hand shapes are examples of what are more generally referred to herein as static poses. Examples of such simple features include, by way of example, mask perimeter, area, width, height, moments, etc. As a number of hand poses in a pose vocabulary increases, some hand poses may be quite similar to one another. For example, a hand pose vocabulary having five or more different hand poses may include two or more hand poses which are similar to one another such that the use of simple features of a hand mask becomes inefficient in terms of performance. When only a few simple features are used, collisions or overlap between similar static poses leads to inefficient performance. Thus, in some embodiments, one or more special or complex features are used to reduce such collisions. Manually adding additional features, however, can dramatically increase complexity of a GR system and lead to a computationally inefficient implementation.

Some embodiments construct an optimal or refined feature set for a given pose vocabulary. In these embodiments, an optimal or refined feature set is constructed in terms of a number of features in the set versus a recognition error rate tradeoff. These embodiments organize a universal set of features that describe a shape of a hand from a 2D binary mask point of view, which allows hand mask reconstruction from the universal set of features. The particular number of features in the universal set of features corresponds to a given desired recognition accuracy which is based in part on the size of the given pose vocabulary. The universal set of features in some embodiments includes a number of basic or simple features describing a hand mask as a whole as well as one or more features that describe the hand contour. Examples of features which describe the hand contour include Fourier coefficients of contour decomposition as well as remainders of the inverse terms of the decomposition. A wide variety of search methods, including Monte Carlo and genetic search methods, can be used to test all or some portion of available features so as to select the universal set of features that meet the given desired recognition accuracy.

The operation of the GR system 108 of image processor 102 will now be described in greater detail with reference to the diagrams of FIGS. 2 through 7.

It is assumed in these embodiments that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

FIG. 2 shows a process for static pose recognition, which includes the following steps:
202. Find a hand region of interest (ROI);
204. Perform static hand pose recognition based on a simple set of features;
206. Select candidate poses based on the recognition results in step 204;
208. Cut the palm using a wrist boundary based on results in step 204; and
210. Perform detailed static hand pose recognition for candidate poses based on a universal set of features.

Each of the above-listed steps of the process 200 will be described in greater detail below. In other embodiments, certain steps may be combined with one another, or additional or alternative steps may be used.

The process begins with step 202, defining a hand ROI. The hand ROI mask for a hand in an input image is implemented as a binary mask in the form of an image, also referred to herein as a “hand image,” in which pixels within the ROI have a certain binary value, illustratively a logic 1 value, and pixels outside the ROI have the complementary value, illustratively a logic 0 value. An ROI may be defined using imager depth information and threshold-based logic. In some embodiments, a pixel (i, j) belongs to the ROI if dₘᵢₙ≦d(i, j)≦dₘₐₓ, where dₘᵢₙ and dₘₐₓ are predefined non-negative constants, e.g., dₘᵢₙ=0 and dₘₐₓ=0.6 meters. Exemplary techniques for determining a hand ROI mask are described in the above-referenced Russian Patent Application No. 2013148582.

An input image in which the hand ROI is identified in step 202 may be supplied by a ToF imager. Such a ToF imager typically comprises a light emitting diode (LED) light source that illuminates an imaged scene. Distance is measured based on the time difference between the emission of light onto the scene from the LED source and the receipt at the image sensor of corresponding light reflected back from objects in the scene. Using the speed of light, one can calculate the distance to a given point on an imaged object for a particular pixel as a function of the time difference between emitting the incident light and receiving the reflected light. More particularly, distance d to the given point can be computed as follows:

$$d = \frac{Tc}{2}$$

where T is the time difference between emitting the incident light and receiving the reflected light, c is the speed of light, and the constant factor 2 is due to the fact that the light passes through the distance twice, as incident light from the light source to the object and as reflected light from the object back to the image sensor. This distance is more generally referred to herein as a depth value.

The time difference between emitting and receiving light may be measured, for example, by using a periodic light signal, such as a sinusoidal light signal or a triangle wave light signal, and measuring the phase shift between the emitted periodic light signal and the reflected periodic signal received back at the image sensor.

Assuming the use of a sinusoidal light signal, the ToF imager can be configured, for example, to calculate a correlation function c(τ) between input reflected signal s(t) and output emitted signal g(t) shifted by predefined value τ, in accordance with the following equation:

$$c ( τ ) = {lim}_{T \to ∞} \frac{1}{T} {\int }_{T / 2}^{- T / 2} s ( t ) g ( t + τ ) d t .$$

In such an embodiment, the ToF imager is more particularly configured to utilize multiple phase images, corresponding to respective predefined phase shifts τₙ given by n π/2, where n=0, . . . , 3. Accordingly, in order to compute depth and amplitude values for a given image pixel, the ToF imager obtains four correlation values (A₀, . . . , A₃), where Aₙ=c(τₙ), and uses the following equations to calculate phase shift φ and amplitude a:

$$ϕ = arc tg ( \frac{{A}_{3} - {A}_{1}}{{A}_{0} - {A}_{2}} ) , \\ a = \frac{1}{2} \sqrt{{( {A}_{3} - {A}_{1} )}^{2} + {( {A}_{0} - {A}_{2} )}^{2}} .$$

The phase images in this embodiment comprise respective sets of A₀, A₁, A₂ and A₃ correlation values computed for a set of image pixels. Using the phase shift φ, a depth value d can be calculated for a given image pixel as follows:

$$d = \frac{c}{4 π ω} ϕ ,$$

where ω is the frequency of emitted signal and c is the speed of light. These computations are repeated to generate depth and amplitude values for other image pixels. The resulting raw image data is transferred from the image sensor to internal memory of the image processor 102 for preprocessing in the manner previously described.

The hand ROI can be identified in the preprocessed image using any of a variety of techniques. For example, it is possible to utilize the techniques disclosed in the above-cited Russian Patent Application No. 2013135506 to determine the hand ROI. Accordingly, step 202 may be implemented in a preprocessing block of the GR system 108 rather than in the static pose recognition module 112.

As described above, the hand ROI may also be determined using threshold logic applied to depth values of an image. In some embodiments, the hand ROI is determined using threshold logic applied to depth and amplitude values of the image. This can be more particularly implemented as follows:

1. If the amplitude values are known for respective pixels of the image, one can select only those pixels with amplitude values greater than some predefined threshold. This approach is applicable not only for images from ToF imagers, but also for images from other types of imagers, such as infrared imagers with active lighting. For both ToF imagers and infrared imagers with active lighting, the closer an object is to the imager, the higher the amplitude values of the corresponding image pixels, not taking into account reflecting materials. Accordingly, selecting only pixels with relatively high amplitude values allows one to preserve close objects from an imaged scene and to eliminate far objects from the imaged scene. It should be noted that for ToF imagers, pixels with lower amplitude values tend to have higher error in their corresponding depth values, and so removing pixels with low amplitude values additionally protects one from using incorrect depth information.

2. If the depth values are known for respective pixels of the image, one can select only those pixels with depth values falling between predefined minimum and maximum threshold depths dₘᵢₙ and dₘₐₓ. These thresholds are set to appropriate distances between which the hand is expected to be located within the image.

3. Opening or closing morphological operations utilizing erosion and dilation operators can be applied to remove dots and holes as well as other spatial noise in the image.

One possible implementation of a threshold-based ROI determination technique using both amplitude and depth thresholds is as follows:

1. Set ROIᵢⱼ=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

The output of the above-described ROI determination process is a binary ROI mask for the hand in the image. It can be in the form of an image having the same size as the input image, or a sub-image containing only those pixels that are part of the ROI. For further description below, it is assumed that the ROI mask is an image having the same size as the input image. As mentioned previously, the ROI mask is also referred to herein as a “hand image” and the ROI itself within the ROI mask is referred to as a “hand ROI.” The output may include additional information such as an average of the depth values for the pixels in the ROI. This average of depth values for the ROI pixels is denoted elsewhere herein as meanZ.

The process in FIG. 2 continues with step 204, performing static hand pose recognition based on a first set of features. In some embodiments, the first set of features is a limited set of features estimated from the hand ROI with low complexity, e.g., with one or two passes of the mask. A wide variety of features may be used for performing step 204, including features which are based on an area of the hand ROI, a perimeter of the hand ROI, a width of the hand ROI, a height of the hand ROI, a forefinger area of the hand ROI, a wrist width of the hand ROI, a forefinger width of the hand ROI, second-order centered moments or functions thereof for coordinates of pixels of the hand ROI, etc. A non-exhaustive list of such features will now be described.

1. Sqrt(area)—the square root of a number of pixels of a ROI or a similar feature calculated from a simplified hand contour.

2. Hand contour perimeter/Sqrt(area)—the number of pixels in perimeter of the hand contour divided by the square root of the area of the ROI. In some embodiments, the pixels in the perimeter of the hand contour are defined as the set of boundary pixels, where boundary pixels are those ones which belong to the ROI and have neighbors from outside the ROI. This feature may also be defined in various other manners.

3. Sqrt(forefinger area/area)—the square root of a number of pixels in a forefinger area divided by the area of the ROI. Exemplary techniques for defining this feature are described in the above-referenced Russian Patent Application No. 2013148582.

4. Sqrt(Cyy)/area—the square root of the second y-coordinate central moment of the ROI divided by the area of the ROI, where pixels in the image are associated with a Cartesian coordinate system having an x-axis and y-axis.

5. Wrist width/Sqrt(area)—the width in pixels of the lower row of the ROI divided by the square root of the area of the ROI.

6. Delta(wrist width)/Sqrt(area)—the difference between the width of the lower row of the ROI and the row delta pixels upper divided by the square root of the area of the ROI, where delta is a constant (e.g., delta=1) or a parameter which is inversely proportional depending on an average distance from a sensor to the hand in the ROI.

7. Egglikeness/Sqrt(area)—“egglikeness” divided by the square root of an area of the ROI. A degree of egglikeness may be determined as follows. Assume that the height of the hand is H, and that w₁=W_{1/4}, w₂=W_{1/2} and w₃=W_{3/4} are the widths of the hand at respective heights h₁=¼*H, h₂=½*H and h₃=¾*H. Using the three points (h₁, w₁), (h₂, w₂) and (h₃, w₃) in two-dimensional space, find a parabola of the form w(h)=a₁*h²+a₂*h+a₃ that goes through all three points. Exemplary techniques for determining the egglikeness are described in the above-referenced Russian Patent Application No. 2013148582.

8. Height/Sqrt(area)—the height of the ROI mask or a height of a minimal bounding rectangle divided by the square root of the area of the ROI.

9. Sqrt(Cxx)/area—the square root of the second x-coordinate central moment of the ROI divided by the area of the ROI.

10. Forefinger width/Sqrt(area)—the width of the top pointing finger defined as the ROI width at htop centimeters (cm) from the uppermost ROI pixel divided by the square root of the area of the ROI. As an example, in some embodiments htop is 2. In other embodiments, different values for htop may be used.

11. Width/Sqrt(area)—the ROI width or a width of a minimum bounding rectangle divided by the square root of the area of the ROI.

12. Max width/Sqrt(area)—the maximum width of a ROI row divided by the square root of the area of the ROI.

13. Width/height—the ROI width divided by the ROI height.

14. Sqrt(Cxx)/Sqrt(Cyy)—the ratio of the corresponding second order central moments of the x- and y-axes.

It should be noted that the above-described hand features are exemplary only, and additional or alternative hand features may be utilized to facilitate static pose recognition in other embodiments, including combinations of the above-described features. For example, various functions of one or more of the above-described hand features or other related hand features may be used as additional or alternative hand features. In addition, functions other than square root may be used in conjunction with hand area, forefinger area, etc. Also, techniques other than those described above may be used to compute the features.

In some embodiments, a subset of the above-described features are used in step 204. The particular number and type of features used may vary depending on available memory, complexity and other limitations.

The above-described hand features can all be calculated at relatively low complexity using one or at most two scanning passes through the ROI mask.

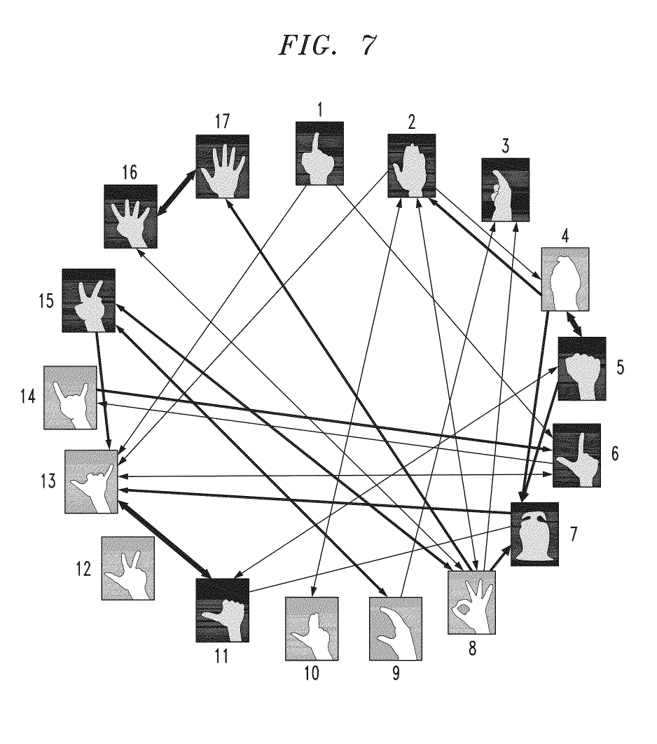

For the selected set of features and a reduced vocabulary of basic poses 201, a collision matrix P is defined as follows. For each 1≦k, l≦N, where N is the number of poses in the vocabulary 201, P(k, l)=probability of a pose from class #k to be recognized as a pose from class #l. Estimation of probabilities may be performed using a testing database for estimating frequencies P(k, l). An example of a collision matrix P is shown in FIG. 7, which will be described in further detail below.

The basic pose vocabulary 201 may be selected using a variety of techniques. In some embodiments, the basic pose vocabulary is selected using expert knowledge. In other embodiments, the following technique is utilized. If P is a collision matrix for basic features and a complete pose vocabulary is denoted B, the basic pose vocabulary A is defined as a subset of B which gives a maximal average value on the main diagonal of collision matrix P or a maximal min value on a diagonal of the corresponding sub-matrix of P among all subsets A of B. Typically, a size M<N of a subset A is an input requirement, and thus selection is made among all subsets of poses with size M or less. A is an example of the basic pose vocabulary 201 and B is an example of the complete pose vocabulary 205.

The process continues with step 206, selecting candidate poses based on recognition results from step 204. Using the similarity measures for the poses from vocabulary A, the set of poses from the complete pose vocabulary B that are candidates for recognition on the second level are selected. The selection of candidates may be based on a pose collision table 203 resulting from the collision matrix P described above. An example of a pose collision table will be described in further detail below.

A table of candidate poses C in some embodiments is defined as follows. Assume that Nₘₐₓ is the maximum number of pose collisions for poses from A and Pₘₐₓ→0 is a maximum collision probability allowed. For each pose k from simplified set A, form an array Par(k) of P(k, l), P(l, k) with k=1, . . . , N excluding k, in descending order. The values of k which are greater or equal to Pₘₐₓ and at the same time reside in the first Nₘₐₓ elements of Par(i) are selected.

In other embodiments, pattern classification techniques are used to select the candidate hand poses from the basic vocabulary 201 in step 206. Examples of such pattern classification techniques include GMMs, neural networks, random decision trees, principal components analysis, etc.

The FIG. 2 process in some embodiments continues with step 208. In these embodiments, the palm boundary is defined and any pixels below the palm boundary are removed from the ROI, leaving essentially only the palm and fingers in a modified hand image. Such a step advantageously eliminates, for example, any portions of the arm from the wrist to the elbow, as these portions can be highly variable due to the presence of items such as sleeves, wristwatches and bracelets, and in any event are not typically useful for static hand pose recognition.

Exemplary techniques that are suitable for use in implementing the palm boundary determination in step 208 in some embodiments are described in the above-referenced Russian Patent Application No. 2013134325.

In other embodiments, alternative techniques are used. For example, the palm boundary may be determined by taking into account that the typical length of the human hand is about 20-25 cm. All pixels located more than a 25 cm threshold distance from the uppermost fingertip along a previously-determined main direction of the hand are removed from the ROI. The uppermost fingertip can be identified as the uppermost point of the hand or as the uppermost 1 value in the binary ROI mask. The 25 cm threshold can be converted to a particular number of image pixels by using an average depth value determined for the pixels in the ROI as mentioned in conjunction with the description of step 202 above.

One or more of the above-described techniques may be used to define the best wrist cut line in step 208. All pixels located below the best wrist cut line may be excluded from the ROI.

The process continues with step 210, performing detailed static hand pose recognition for the candidate poses determined in step 206 based on a universal set of features. Step 210 uses the complete vocabulary of poses 205. In step 210, the process selects the most likely pose from the full vocabulary B based on the universal set of hand pose features. In some embodiments, the selection is performed using maximal likelihood methods using similarity measures based on a pattern classification method such as GMMs, neural network, random decision trees, principal components analysis, etc. As shown in FIG. 2, the process includes Level 1 and Level 2 processing. Whereas the Level 1 processing, particularly step 204, uses a first set of basic features, the Level 2 processing in step 210 uses the universal set of features.

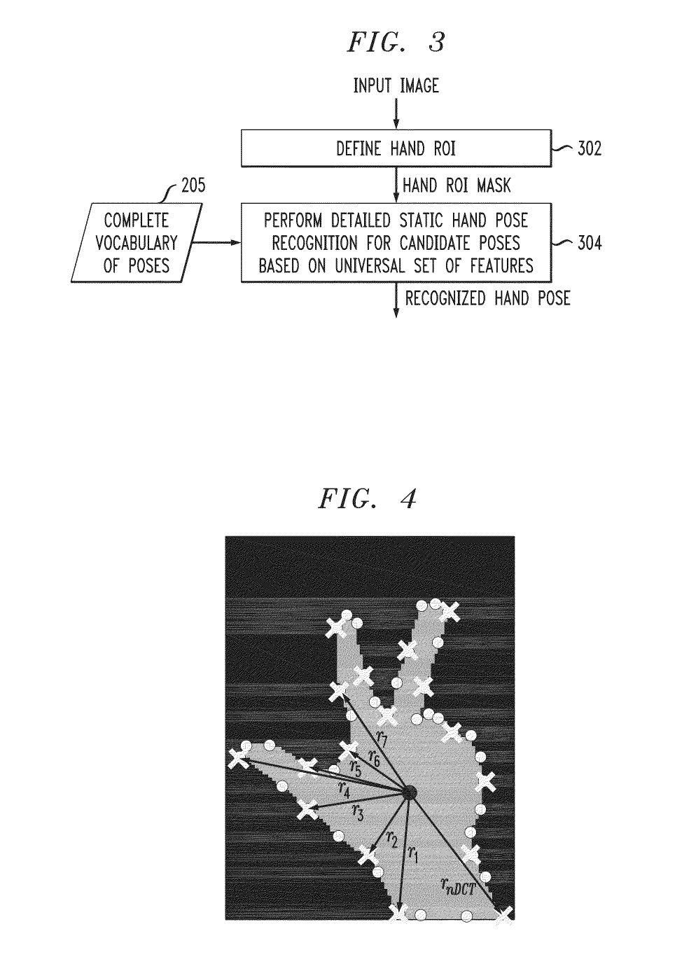

FIG. 3 shows an alternate embodiment that utilizes single-level processing. Step 302 in FIG. 3 is similar to the processing performed in step 202 in FIG. 2 as described above. Rather than performing Level 1 processing as described above, FIG. 3 performs detailed static hand pose recognition for candidate poses based on the universal set of features in step 304, where the candidate poses include the complete pose vocabulary 205.

The universal set of features used in step 210 in FIG. 2 or step 304 in FIG. 3 may include all 14 of the basic features described above, and in addition one or more features derived from a transform on the contour of the hand ROI. In some embodiments, the transform is one of a discrete cosine transform and wavelet transform, although alternative transform techniques may be used in other embodiments. The universal set of features may further include a residual feature determined based in part on the transform on the contour of the hand ROI.

In some embodiments, features derived from a transform on the contour of the hand ROI are obtained as follows. First, the center of the hand ROI is identified. Second, a vector is obtained by estimating respective distances from a subset of contour points of the hand ROI to the center of the hand ROI. Third, the vector is transformed using a transform function such as a discrete cosine transform, a wavelet transform or other Fourier-like transform to obtain a set of coefficients. More detailed examples for obtaining the set of coefficients are described below.

Let a set of pixels (xᵢ, yᵢ) i=1, . . . , n represent the contour of the hand ROI. As an example, i=1 may correspond to the left bottom corner of the hand ROI and contour tracking may be done in a clockwise order. The set of pixels thus represents an ordered list of points characterizing the general shape of the hand ROI.

Let nDCT correspond to some predefined constant number of transform coefficients, referred to herein as DCT. Although DCT and nDCT are used to refer to the transform coefficients and the corresponding number thereof, the coefficients are not limited solely to discrete cosine transform coefficients. Instead, as described above, the transform may be a wide variety of transforms, such as wavelet and other Fourier-like transforms. In some embodiments, nDCT is 32.

Let (mₓ, m_{y}) correspond to the “center” of the hand in a Cartesian coordinate system comprising an x-axis and a y-axis. The center may be determined in a number of different ways. In some embodiments, the center of mass of the hand ROI mask points is used as the center of the hand. In other embodiments, the center of a largest inscribed circle in the hand ROI is used as the center. In still other embodiments, the pair of points (mₓ, m_{y}) is identified where mₓ is the x-coordinate center of the largest inscribed circle in the hand ROI, and m_{y} is calculated by subtracting a constant value dy from ybottom. dy corresponds to a fixed constant in cm, such as 5 cm, which is recalculated in pixels using a known average distance from the hand to the camera for the image. ybottom is the y-coordinate of the lower row of the ROI.

A ROI contour scan may be performed using a variety of operations. In some embodiments, a contour perimeter P is estimated and used to form a subset (xⱼ, yⱼ) of the contour points (xᵢ, yᵢ), where j=1, . . . , nDCT. The distance between adjacent contour points in the subset is approximately equal to P/(nDCT−1).

In other embodiments, the contour points (xᵢ, yᵢ) are tracked to form the subset of contour points (xⱼ, yⱼ). The distance between adjacent contour points is approximately equal to some predefined constant step, such as 5 pixels. If a full contour circuit is made, tracking is stopped. If the full circuit gives less than nDCT points, the subset is appended with (0, 0) points until its length is equal to nDCT. Alternatively, if a full contour circuit is made tracking may be continued until nDCT points are obtained.

After obtaining the subset of contour points using one of the above techniques or an alternative technique, distances from the subset of contour points to the center (mₓ, m_{y}) of the hand are determined according to the equation:

rⱼ=\sqrt{(xⱼ−mₓ)²+(yⱼ−m_{y})²,}j=1, . . . ,nDCT

The vector r=(r₁, r₂, . . . r_{nDCT}) is then transformed using a DCT, wavelet or other invertible Fourier-like transform to form coefficients DCT(r)=(DCT₀, DCT₁, . . . , DCT_{nDCT-1}). As described above, the notation DCT is used for illustrative purposes and is not intended to limit embodiments solely to use with discrete cosine transforms.

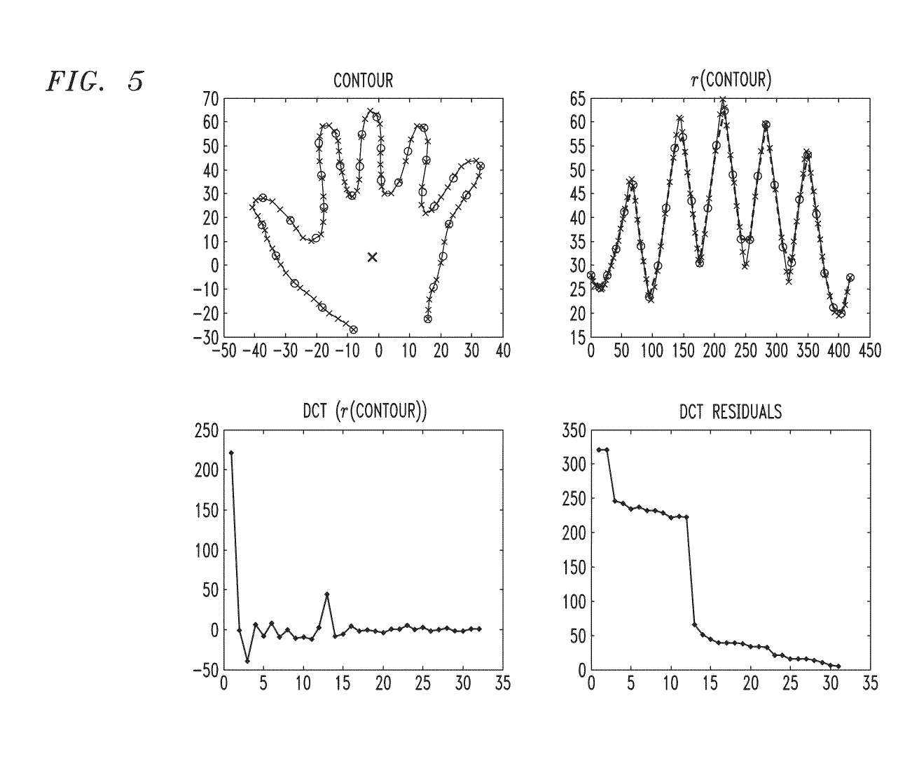

FIG. 4 shows an example of identifying the subset of contour points using the contour perimeter estimation technique described above. White dots in FIG. 4 correspond to contour points, and white X's in FIG. 4 correspond to the subset of decimated contour points. The black dot shows the center of the hand ROI. The subset of contour points is then processed using a transform to form the coefficients DCT(r) as described above. The coefficients DCT(r) are an example of a feature derived from a transform on the contour of the hand ROI.

The coefficients DCT(r) may be further processed to obtain a residual feature. An example of such processing is described below. If a set of DCT coefficients (DCT₀, DCT₁, . . . , DCT_{nDCT-1}) are available for the contour, the residual coefficient for index j, j=0, . . . , nDCT is estimated as follows. For each index j, the tail of DCT coefficients is replaced with zeroes. For example, (DCT₀, DCT₁, . . . , DCT_{nDCT-1})→(DCT₀, DCT₁, . . . , DCTⱼ, 0, 0, . . . , 0). An inverse transform is applied to the truncated vector to obtain iDCTⱼ=iDCT(DCT₀, DCT₁, . . . , DCTⱼ, 0, 0, . . . , 0) where iDCT is the inverse transform function. Next, the difference between the original vector r and iDCTⱼ is determined, such that the residual feature for index j is determined according to the following equation:

DCTᵣₑₛ(j)=dist(r,iDCTⱼ)

where dist represents a distance function. The distance function may be a Euclidian, Manhattan, maximum absolute difference metric, or a variety of other distance metrics.

FIG. 5 illustrates a procedure for obtaining DCT coefficients and residuals from a contour scan. FIG. 5 shows four graphs. The upper-left corner graph shows the contour of a hand ROI, where the large X denotes the center and the circles represent the subset of contour points. The upper-right corner graph shows the vector r. The lower-left corner graph shows the set of DCT coefficients and the lower-right corner graph shows the DCTᵣₑₛ coefficients.

In some embodiments, the universal set of features used in step 210 in FIG. 2 or step 304 in FIG. 3 contains the list of 14 basic features described above, the set of DCT coefficients and the set of DCTᵣₑₛ coefficients. If the universal set of features is too large for current complexity, processing or memory limitations of a given image processor, an exhaustive search, Monte Carlo, genetic or other search technique may be used to reduce the set of features while keeping performance of pose recognition within predefined limits. In some embodiments, the universal set of features comprises first and second sets of features, where the first set of features comprises two or more features from the set of basic features and the second set of features comprises the DCT and DCTᵣₑₛ coefficients.

The first set of features may comprise two or more of an area of the hand ROI, a perimeter of the hand ROI, a width of the hand ROI and a height of the hand ROI in addition to one or more of a forefinger area of the hand ROI, a wrist width of the hand ROI and a forefinger width of the hand ROI or one or more of second-order centered moments or functions thereof for coordinates of pixels of the hand ROI.

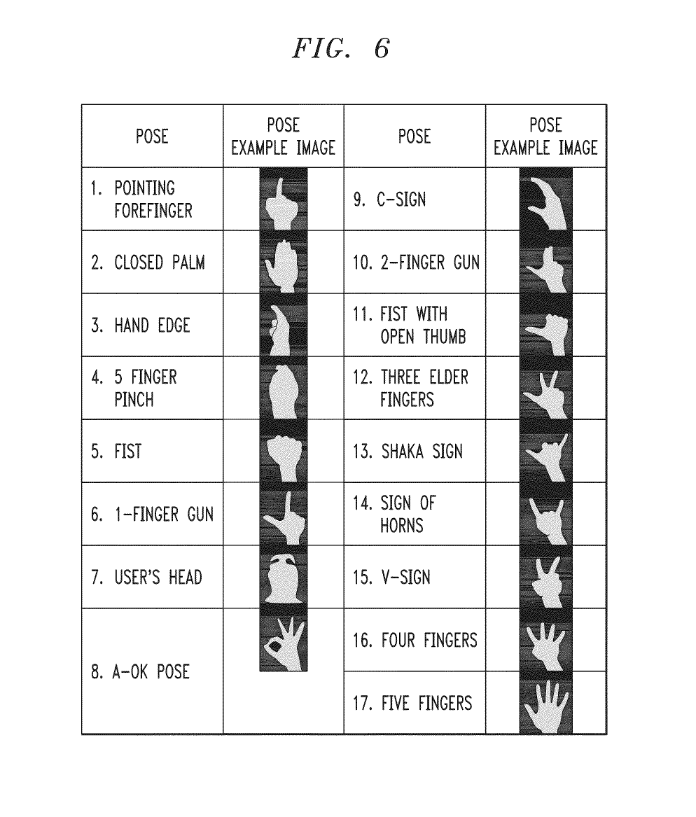

FIG. 6 shows an example of a full pose vocabulary having 17 poses. The pose vocabulary 205 may include the 17 poses shown in FIG. 6. It is to be appreciated, however, that the particular pose vocabulary shown in FIG. 6 is presented by way of example only, and that a complete pose vocabulary in other embodiments may have more or less than 17 poses.

A subset of the poses shown in FIG. 6 may be used as the reduced pose vocabulary 201 for Level 1 processing in FIG. 2. By way of example, the reduced pose vocabulary 201 may include poses 1, 2, 3, 5, 6, 7, 11, 15, 16 and 17. The following table is an example of the pose collision table 203 used in step 206 of the Level 1 processing in FIG. 2. The pose collision table, as discussed above, shows the candidate poses for Level 2 processing in FIG. 2 based on the pose recognized in step 204 in the Level 1 processing:

Pose collision table

| Pose recognized | Candidate poses |
|---|---|
| In Level 1 | for Level 2 |
| 1 | 1, 6, 13 |
| 2 | 2, 4, 8, 10, 13 |
| 3 | 3, 8, 9 |
| 5 | 4, 5, 7, 11 |
| 6 | 6, 13, 14 |
| 7 | 4, 5, 7, 8, 13 |
| 11 | 5, 7, 11, 13 |
| 15 | 8, 9, 13, 15 |
| 16 | 8, 16, 17 |
| 17 | 8, 16, 17 |

FIG. 7 shows an example of a pose collision graph. Basic poses used for Level 1 processing are shown in bold, with the hand in gray and a black background. The remaining poses are shown with the hand in white and a gray background. Bolder arrows shown in FIG. 7 correspond to stronger collisions, and collision direction corresponds to the orientation of edges.

To recognize candidate poses in step 204 or the hand pose in step 210 or step 304, various classification techniques may be utilized. In some embodiments, each static pose in a vocabulary utilizes a corresponding classifier configured in accordance with a classification technique such as, for example, GMMs, nearest neighbor, decision trees and neural networks. Additional details regarding the use of classifiers based on GMMs in the recognition of static hand poses can be found in the above-cited Russian Patent Application No. 2013134325.

The particular types and arrangements of processing blocks shown in the embodiments of FIGS. 2 and 3 are exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, these embodiments provide computationally-efficient static pose recognition using estimated hand features. The estimated hand features comprise first and second sets of features, where respective numbers of features in the first and second sets are based at least in part on a size of a vocabulary of hand gestures used for recognition. The disclosed techniques can be applied to a wide range of different GR systems, using depth, grayscale, color, infrared and other types of imagers which support a variable frame rate, as well as imagers which do not support a variable frame rate. Some embodiments are particularly well-suited to instances where source images are low-resolution, as the contour of a hand ROI may be obtained from low-resolution images whereas other types of features such as palm texture are difficult or impossible to obtain from low-resolution images.

Different portions of the GR system 108 can be implemented in software, hardware, firmware or various combinations thereof. For example, software utilizing hardware accelerators may be used for some processing blocks while other blocks are implemented using combinations of hardware and firmware.

At least portions of the GR-based output 113 of GR system 108 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

1. A method comprising steps of:
identifying a hand region of interest in at least one image;
obtaining a vocabulary of hand poses;
estimating a plurality of hand features based on the hand region of interest, the plurality of hand features comprising a first set of features estimated from the hand region of interest and a second set of features comprising at least one feature estimated using a transform on a contour of the hand region of interest; and
recognizing a static pose of the hand region of interest based on the first set of features and the second set of features, wherein respective numbers of features in the first set of features and the second set of features are based at least in part on a size of the vocabulary of hand poses;
wherein the steps are implemented in an image processor comprising a processor coupled to a memory.

2. The method of claim 1 wherein identifying the hand region of interest comprises generating a hand image comprising a binary region of interest mask in which pixels within the hand region of interest all have a first binary value and pixels outside the hand region of interest all have a second binary value complementary to the first binary value.

3. The method of claim 1 wherein recognizing the static pose of the hand region of interest comprises:
determining a set of candidate hand poses from a subset of the vocabulary of hand poses based on the first set of features; and
recognizing the static pose based on the set of candidate hand poses, the first set of features and the second set of features.

4. The method of claim 1 wherein the first set of features comprises two or more of an area of the hand region of interest, a perimeter of the hand region of interest, a width of the hand region of interest and a height of the hand region of interest.

5. The method of claim 4 wherein the first set of features further comprises one or more of a forefinger area of the hand region of interest, a wrist width of the hand region of interest and a forefinger width of the hand region of interest.

6. The method of claim 4 wherein the first set of features further comprises one or more of second-order centered moments or functions thereof for coordinates of pixels of the hand region of interest.

7. The method of claim 1 wherein the transform on the contour of the hand region of interest comprises one of a discrete cosine transform and a wavelet transform.

8. The method of claim 1 wherein said at least one feature estimated using the transform on the contour of the hand region of interest is estimated by:
identifying a center of the hand region of interest;
obtaining a vector by estimating respective distances from a subset of contour points of the hand region of interest to the center of the hand region of interest; and
transforming the vector to obtain a set of coefficients.

9. The method of claim 8 wherein identifying the center of the hand region of interest comprises one of:
identifying a center of mass of mask points in the hand region of interest;
identifying a center of a largest inscribed circle in the hand region of interest; and
identifying a pair of points (mₓ, m_{y}) in a Cartesian coordinate system comprising an x-axis and a y-axis wherein mₓ corresponds to an x-coordinate center of the largest inscribed circle in the hand region of interest and m_{y} is calculated by subtracting a constant value dy from ybottom, where dy corresponds to a fixed constant based on a distance between the hand and the camera capturing said at least one image and ybottom is a y-coordinate of a lowest row of pixels in the hand region of interest.

10. The method of claim 8 further comprising determining the subset of contour points by one of:
estimating a contour perimeter of the hand region of interest and selecting points on the contour such that respective distances between adjacent points in the subset is based on the contour perimeter and a predetermined number of contour points to be included in the subset; and
tracking points of the contour and selecting ones of the points of the contour to include in the subset such that respective distances between adjacent points in the subset are approximately equal to a predefined constant step.

11. The method of claim 10 wherein tracking points of the contour comprises tracking a circuit of the contour of the hand region of interest and, if a full circuit gives less than the predetermined number of contour points, appending the subset with (0, 0) points until the number of contour points in the subset is equal to the predetermined number.

12. The method of claim 8 wherein the second set of features further comprises a residual feature determined by processing the set of coefficients obtained by transforming the vector.

13. The method of claim 12 wherein the set of coefficients are associated with respective indices and wherein processing the set of coefficients comprises, for each index:
replacing a tail of the set of coefficients with zeros to obtain a truncated vector of the set of coefficients;
applying an inverse transform to the truncated vector; and
estimating a difference between the vector and the truncated vector using a distance metric.

14. The method of claim 13 wherein the distance metric comprises one of a Euclidean distance metric, a Manhattan distance metric and a maximum absolute difference metric.

15. (canceled)

16. An apparatus comprising:
an image processor comprising image processing circuitry and an associated memory;
wherein the image processor is configured to implement a gesture recognition system utilizing the image processing circuitry and the memory, the gesture recognition system comprising a static pose recognition module; and
wherein the static pose recognition module is configured:
to identify a hand region of interest in at least one image;
to obtain a vocabulary of hand poses;
to estimate a plurality of hand features based on the hand region of interest, the plurality of hand features comprising a first set of features estimated from the hand region of interest and a second set of features comprising at least one feature estimated using a transform on a contour of the hand region of interest; and
to recognize a static pose of the hand region of interest based on the first set of features and the second set of features, wherein respective numbers of features in the first set of features and the second set of features are based at least in part on a size of the vocabulary of hand poses.

17. The apparatus of claim 16 wherein the static pose recognition module is configured to recognize the static pose of the hand region of interest by determining a set of candidate hand poses from a subset of the vocabulary of hand poses based on the first set of features and to recognize the static pose based on the set of candidate hand poses, the first set of features and the second set of features.

18. The apparatus of claim 16 wherein the transform on the contour of the hand region of interest comprises one of a discrete cosine transform and a wavelet transform.

19. (canceled)

20. (canceled)

21. The apparatus of claim 16 wherein the first set of features comprises two or more of an area of the hand region of interest, a perimeter of the hand region of interest, a width of the hand region of interest and a height of the hand region of interest.

22. The apparatus of claim 21 wherein the first set of features further comprises one or more of a forefinger area of the hand region of interest, a wrist width of the hand region of interest and a forefinger width of the hand region of interest.

23. The apparatus of claim 21, wherein the first set of features further comprises one or more of second-order centered moments or functions thereof for coordinates of pixels of the hand region of interest.
